(19) United States
(12) Patent Application Publication
(10) Pub. No.: US 2010/0071564 A1
(43) Pub. Date: Mar. 25, 2010

(54) Small batch deep fryer

(76) Inventors: Edward Michael Jones, Stratford, CT (US); Christopher Edward Jones, Stratford, CT (US)

Correspondence Address: Edward Michael Jones, 200 Morningside Ter., Stratford, CT, 06614, US

(21) Appl. No.: 12/584,979

(22) Filed: Sep. 15, 2009

Related U.S. Application Data
(60) Provisional application No. 61/191,960, filed on Sep. 15, 2008.

(51) Int. Cl. A47J 37/12

(52) U.S. Cl. 99/418

(57) ABSTRACT

A deep fryer that saves oil and expedites the deep frying process when frying small batches of food. By reducing the size of the lower portion of the food basket and oil pot with the present invention the user need only fill a smaller cubic area of the lower portion of the oil pot thereby reducing the amount of oil needed when cooking small batches of food which in turn saves the user money. Since the lower portion of the oil pot and food basket are smaller in cubic area than their respective upper portions less oil is needed to be heated thereby reducing the time for frying small batches of food. This saves time and energy costs.

A large batch of food can also be fried in the present invention by simply adding more oil to utilize the entire oil pot and food basket.

### CROSS REFERENCE TO RELATED APPLICATIONS

Provisional Patent (Application No. 61/191/960) filed Sept. 15, 2008 by Edward M. Jones and Christopher E. Jones

### References Cited

U.S. Patent Documents

| | | |
|---|---|---|
| U.S. Pat. No. 6,845,707 | January 2005 | Zhaoxia, Xu |
| U.S. Pat. No. 5,027,697 | Jul. 2, 1991 | Assignee: Delonghi |
| U.S. Pat. No. 5,543,166 | Aug. 6, 1996 | Masel |
| U.S. Pat. No. 6,453,801 | Sep. 24, 2002 | Masel |
| U.S. Pat. No. 5,611,265 | Mar. 18, 1997 | Ronci |

Foreign Patent Documents

| | | |
|---|---|---|
| CN 763467 | April 2008 | Assignee: Linkco Industries |

### STATEMENTS REGARDING FEDERALLY SPONSORED RESEARCH OR DEVELOPMENT

Not Applicable

### BACKGROUND OF THE INVENTION

There are many times when users of deep fryers want to fry a small batch of food but have to use an large amount of oil to accomplish this due to the large cubic area of the oil pot that needs to be filled in order to accomplish the submersion of food in hot oil which is needed for deep frying. The disposal of large quantities of used oil becomes a problem.

The present invention relates to a deep fryer that provides the ability to deep fry small batches of food using a minimal amount of oil when deep frying small batches of food is desired. The aforementioned is accomplished by utilizing the lower portion of the food basket and oil pot that are both smaller than the upper portion in cubic area. However large batches of food can be fried by filling the entire oil pot and utilizing the entire food basket with food.

To accomplish deep frying a sufficient quantity of oil is needed so that when food is placed in the food basket and subsequently lowered into the oil the food is submerged thereby accomplishing deep frying. When frying small batches of food with current deep fryers on the market a greater amount of oil is needed to fill the entire lower portion of the oil pot to allow the submersion of food because the bottom portion of the pot is the same cubic area as the top portion to fill thereby requiring the same amount of oil for small batches of food as large batches of food. The present invention requires less oil because of there is smaller cubic area at the bottom of the oil pot and food basket than the upper portion.

The current deep fryers on the market take a longer time to heat oil to the required frying temperature when frying small batches of food because they have greater amount of oil to heat than what is required with the present invention to fry the same small batch of food. The present invention oil temperature recovery time is faster when cold food is added to the fryer basket and lowered into the oil because there is less oil to re-heat when frying small batches of food therefore allowing the oil temperature to rise faster reducing the absorption oil of food and providing better tasting deep fried food. Current deep fryers on the market take a longer time to reheat oil back up to frying temperature when cold food is lowered into the oil when frying small batches of food because there is a larger volume of oil to re-heat.

Larger size batches of food can also be fried in the present invention by filling the entire pot with oil thereby allowing for the food basket to be filled and the food to be submerged to accomplish deep frying of larger batches of food.

There are several inventions in the deep fryer field that relate to the present invention as it relates to the use of less oil. U.S. Pat. No. 6,845,707 describes the use of a paddle to stir food that is partially immersed in hot oil which saves oil but defeats the purpose of deep frying which is totally immersing food in hot oil and attaining the unique taste of deep frying.

U.S. Pat. Nos. 6,834,577, 5,027,697, 5,543,166, 5,611,265, and 6,453,801 relate to a drum system that rotates food through oil which reduces the need for larger quantities of oil but they also miss the point of deep frying and that is obtaining the distinctive taste of having food submerged and cooked in oil.

China Design Pat. 763467 addresses the use of less oil by having a recessed area at the bottom of their oil pot which is intended to use less oil. But the shape of the oil pot and the food basket plus the fact that the heating element does not sit in the oil prevents the user from using that oil thereby defeating the purpose of saving oil. In actual usage the oil needed to fill the oil pot and obtain a level of oil in the food basket to fry a small batch of food should be more that current deep fryers on the market thereby not addressing the small batch deep frying.

### SUMMARY OF THE INVENTION

The present invention is intended to reduce the amount of oil needed when frying small batches of food, improve the cooking time by reducing initial heat-up time and improving temperature recovery time when cooking small batches of food. However large batches of food can also be fried in the present invention by utilizing the entire oil pot and food basket.

The present invention has an oil pot that sits inside the deep fryer housing and its shape can be rectangular, square, round or oval or conical. It can be made from aluminum, metal, stainless steel or any combination there of. The square or cubic area at the lower portion of the pot is smaller than the cubic area at the upper portion of the pot.

The lower portion of the food basket will be formed to fit to the lower portion of the oil pot. The upper portion of the food basket has a larger cubic area than the lower portion of the food basket. The food basket may be rectangular, square, round, oval, or conical. It can be made of a stainless steel, aluminum or any metal. It may be in any configuration such as depicted in the drawing but not limited to a wire mesh design. The food basket configuration as an example may be a solid metal material with holes in it.

The present invention will have a heating system that will utilize either exposed calrod elements that sit in the bottom of the oil pot or heating elements that are cast into the external or internal bottom of the oil pot or the heating elements may sit in a channel at the outside bottom of the pot or oil pot may simple rest on the heating elements or be positioned close to the heating elements. or yet pot that rests on heating elements.

The present invention will have the following controls but may have more or less controls depending upon the need: a thermostat control, a cooking timer, an on-off switch, a ready light. The controls may be attached to the heating element or to the housing.

The housing of the present invention can be any shape such as rectangular, square, round, oval, or conical and be made from any material including but not limited to plastic, metal, aluminum, stainless steel.

The present invention will have quick easy release cord.

The lid/cover may or may not be mounted to the housing with hinges. It will be removable for cleaning. It may or may not have a view window and a filter for reducing odors and smoke.

### BRIEF DESCRIPTION OF DRAWINGS

FIG. 1 a perspective view of the deep fryer depicting all parts of present invention and the manner in which they fit together along with a visual perspective of the small batch oil level and food.

FIG. 2 the oil pot depicting the lower portion and the corresponding smaller cubic area.

FIG. 3 shows side view of the food basket

FIG. 4 a front view of the food basket which depicts the lower portion of the food basket and corresponding smaller cubic area.

FIG. 5 a view of the entire fryer

FIG. 6 an exploded and cut-away view of the fryer depicting the smaller cubic areas of the oil pot, food basket, and control panel.

### DETAILED DESCRIPTION OF THE PREFERRED EMBODIMENT

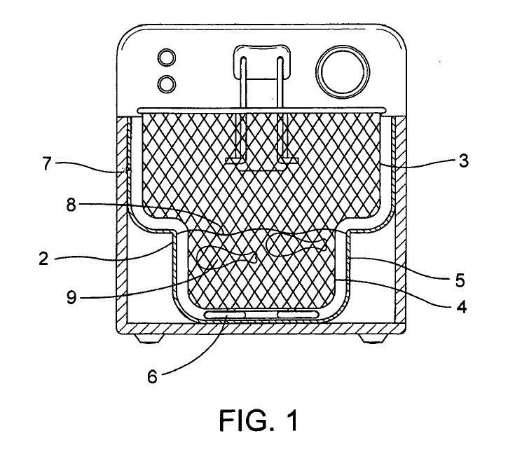

As shown in FIG. 1 a front cut away depicts the oil pot 2 and food basket 3 with their lower portions or small batch area 5 and 4 respectively smaller in cubic are than their upper portions. As shown the oil level 8 at the top of the recessed area of the oil pot 2 and food basket 3 and food 9 is shown in the smaller cubic area of the food basket 3. A heating element 6 is shown in the smaller cubic area of the oil pot 5. The deep fryer housing is depicted in 7.

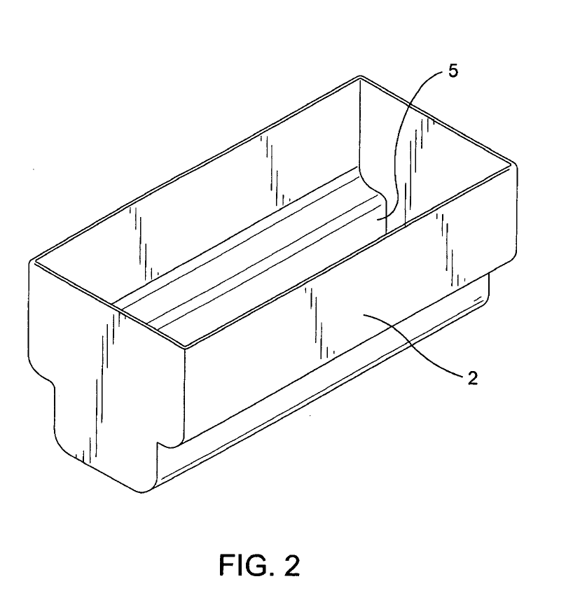

As shown in FIG. 2 the oil pot 2 and the reduced cubic area of the oil pot 5.

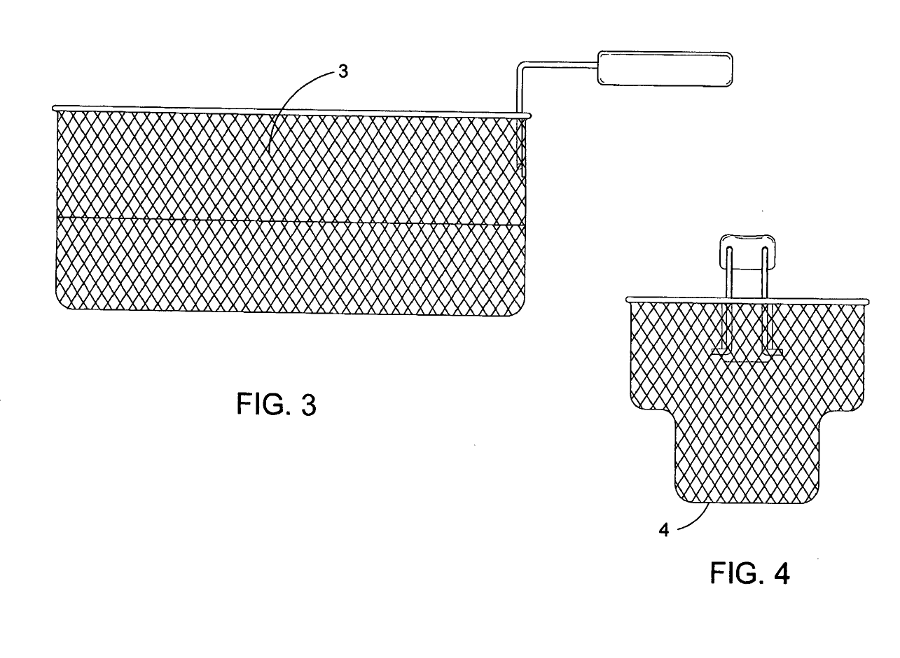

As shown in FIG. 3 the food basket 3 and the reduced cubic area of the food basket 4.

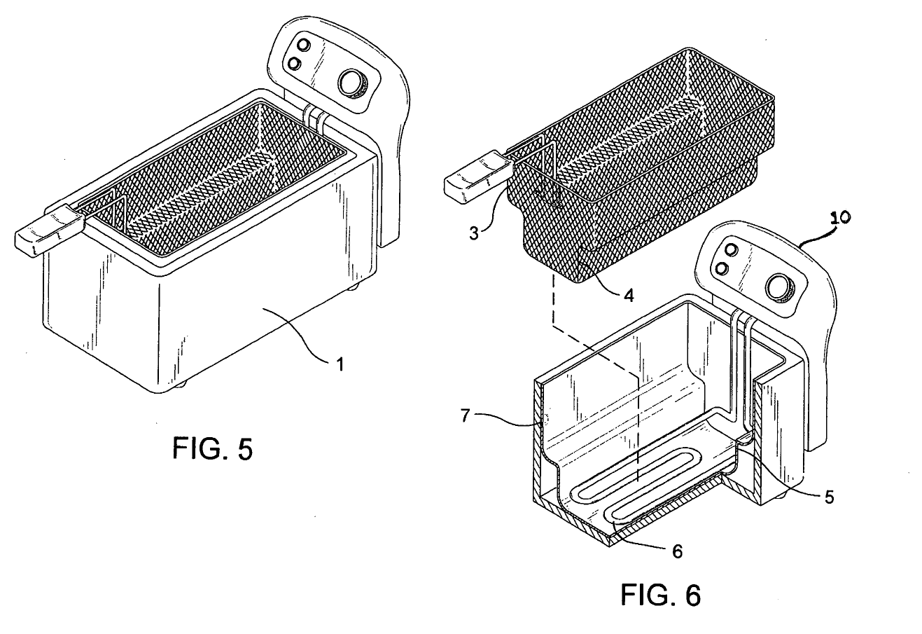

As shown in FIG. 5 the deep fryer as a complete entity 1.

As shown in FIG. 6 the deep fryer 1 as a an exploded view and sectional cut away depicting the food basket 3 and the lower smaller cubic area of the food basket 4 and the manner in which it fits into the oil pot 2 and the manner in which the smaller cubic area of the food basket 4 fits into the smaller cubic area of the oil pot 5. The heating element 6 is shown at the bottom of the smaller cubic area of the oil pot 5. The deep fryer housing 7 that holds the oil pot 2, the food basket 3, the heating element 6, and the control panel 10.

What is claimed:

1. A deep fryer that has an oil pot which has a smaller cubic area in its lower portion than its upper portion.

2. A deep fryer that has a food basket that has a smaller cubic area in its lower portion than its upper portion and which lower portion sits in the lower portion of the oil pot

3. A deep fryer in which the heating element sits in the smaller cubic area of the oil pot or is directly below the smaller cubic area of the oil pot

4. A deep fryer in which the oil heats up faster in the initial heat-up stage when frying small batches of food

5. A deep fryer in which less oil is used when frying small batches of food since only the smaller cubic area in the bottom of the oil pot has to be filled.

6. A deep fryer that has a faster temperature recovery time when the initial batch of food is cooked and smaller batches of food is added to be fried.
